(19) United States
(12) Patent Application Publication
(10) Pub. No.: US 2022/0097151 A1
(43) Pub. Date: Mar. 31, 2022

(54) CUTTING INSERT FOR HIGH FEED FACE MILLING

(71) Applicant: Kennametal Inc., Latrobe, PA (US)

(72) Inventor: Jean Luc Dufour, Greensburg, PA (US)

(73) Assignee: Kennametal Inc., Latrobe, PA (US)

(21) Appl. No.: 17/034,121

(22) Filed: Sep. 28, 2020

(51) Int. Cl. B23C 5/10

(52) U.S. Cl. CPC B23C 5/109

(57) ABSTRACT

A cutting insert for milling operations, such as, face milling, slot milling, plunge milling, and ramping operations. The cutting insert exhibits a combination of favorable cutting-edge strength, and unique cutting-edge geometry to allow milling operations at relatively high feed rates. The cutting insert includes at least four convex cutting edges. Certain embodiments of square cutting inserts will have four convex cutting edges connected by nose corner regions. Each convex cutting edge includes a first curved cutting-edge region having a radius greater than or equal to two times a radius of the largest circle that may be inscribed on the top surface. Each convex cutting edge also includes a second curved cutting-edge region adjacent the first curved cutting-edge region and having a radius less than or equal to the diameter of the inscribed circle. Each convex cutting edge may also include one or more straight cutting-edge regions.

### CROSS NOTING TO RELATED APPLICATIONS

This application is related to application Ser. No. 10/686,308, now U.S. Pat. No. 7,220,083.

### FIELD OF THE DISCLOSURE

The disclosure is directed to a cutting insert. The cutting insert exhibits a combination of favorable cutting edge strength, and unique cutting edge geometry, thus, allowing milling operations at relatively high feed rates and may be useful in face milling, slot milling, plunge milling, and ramping operations.

### BACKGROUND OF THE DISCLOSURE

Traditional machining methods, which are the principal means of removing metal from workpieces, include chip cutting (such as milling, drilling, turning, broaching, reaming, and tapping) and abrasive machining methods (such as sanding, grinding, and polishing. One such chip cutting process, face milling, may be useful to produce a generally flat surface on a workpiece. A face milling tool or “face mill” is so named because the flat workpiece surface is produced by action of the face of the tool, although the outside diameter or bevel cutting edge removes most of the stock. In a typical application, a milling cutter tool comprising a number of cutting inserts may be driven by a spindle on an axis positioned perpendicular to the surface being milled. ASM Handbook, Volume 16, “Machining” (ASM Intern. 1989) p. 311.

A milling cutter tool produces chips with variable chip thickness. Chip thickness may be used in calculating the maximum load per unit length exerted on the edges of a milling cutting tool. An average chip thickness is typically used in such calculations. Average chip thickness can be calculated and varies with cutting insert lead angle for the same material feed rate. For the example of a substantially square-shaped insert having four identical cutting edges, a larger lead angle produces a larger average chip thickness during machining, while a smaller lead angle produces chips of smaller average thickness. An example of the variation of average chip thickness with lead angle of the insert is shown in FIG. 1.

FIG. 1 illustrates a comparison of an identical square-shaped insert machining with lead of angles of 90°, 75°, and 45°. As indicated in the FIG. 1, as the lead angle increases from 45° in FIG. 1(a), to 75° in FIG. 1(b), to 90° in FIG. 1(c), the average chip thickness (hₘ) increases from 0.71 times the feed per tooth of the holder (“fz”), to 0.97×(fz), to fz. More generally, the chip thickness for a square-shaped cutting insert, or any other insert having a linear cutting edge used in a milling cutter tool, may be calculated using the equation hₘ=fz×sin(K), where hₘ is the average chip thickness, and K is the lead angle measured in the manner shown in FIG. 1.

FIG. 1 also indicates that the length of engaged cutting edge when using a 90° lead angle is shortest among those scenarios shown in FIG. 1, while the length of engaged cutting edge is longest when the lead angle is 45°. This means that face milling using a 90° lead angle produces more load, i.e., higher stresses, on the cutting edge per unit length compared with milling using a 45° lead angle, for the same depth of cut. An advantage of reducing load on the cutting edge per unit length is that reduced load allows for employing a higher feed rate per tooth in the milling operation and improved tool life. Thus, to reduce the average load stresses on the engaged cutting edge, it is clearly an advantage to use a smaller lead angle.

Square-shaped cutting inserts are commonly used in face and plunge milling because they are strong, indexable and have multiple cutting edges. Inserts having a substantially square shape or otherwise including four cutting edges are disclosed in, for example, U.S. Pat. Nos. 5,951,212 and 5,454,670, U.S. Published Application No. 2002/0098049, Japanese reference No. 08174327, and PCT Publication No. WO 96/35538. A common feature of the inserts disclosed in these references is the combination of four straight cutting edges and either a planar or a bevel planar clearance (or relief) surface below each cutting edge.

It is well-known that round-shape inserts, however, have the strongest cutting edge. In addition, round-shaped inserts provide a favorable combination of maximal corner strength, good material removal capacity, mechanical shock resistance, and thermal distribution. As such, round-shaped face milling inserts are often used for the more demanding machining applications, such as those involving difficult-to-cut materials, hard materials, heat resistant materials, titanium, etc. In face milling using a round-shaped cutting insert, the lead angle and the extent of the engaged cutting edge will vary with the depth of cut, as shown in FIG. 2. The average chip thickness produced by a round-shape insert can be approximately calculated by the following equation (I):

$${h}_{m} = \frac{{f}_{z}}{R} \sqrt{{R}^{2} - {( R - d o c )}^{2}} \qquad ( I )$$

where hₘ is the average chip thickness, f_{z} is the feed per tooth from a milling cutter, R is the radius of the round-shape cutting insert, and doc is the depth of cut. The above equation indicates that when cutting with a round-shaped insert, chip thickness varies with depth of cut. In contrast, when cutting using a square-shaped insert or any insert having a linear cutting edge, chip thickness does not change with changes in the depth of cut if the lead angle remains the same (see FIG. 1)

Furthermore, for the same depth of cut, a larger radius of a round-shaped insert always corresponds to a larger portion of the cutting edge engaging the work piece, as illustrated in FIG. 3, thus, reducing the average stress load per unit length on the cutting edge. This, in turn, allows the use of higher feed rates during face milling without a loss of quality. However, a limitation of a round-shaped cutting insert lies in that the larger the radius, the larger the insert. It is difficult to fully utilize the advantages provided by round-shaped inserts of increasingly larger radius in conventional machining applications due to their size.

Accordingly, to overcome the cutting edge load problems that may be encountered in face milling with large lead angles, there is a need for an improved design of cutting insert that allows for significantly increased feed rates during face milling operations while maintaining the same or longer tool life of the cutting inserts. Also, there is a need for a new cutting insert that is similar to a round-shaped insert in that it exhibits favorable cutting edge strength, but also is similar to a square-shaped insert in that it includes multiple cutting edges, is indexable, and also allows for a high feed rate and favorable wear properties.

### SUMMARY OF THE DISCLOSURE

The problem of significantly increasing feed rates during face milling operations while maintaining the same or longer tool life of the cutting inserts is solved by providing a cutting insert for milling operations, such as, face milling, slot milling, plunge milling, and ramping operations. The cutting insert exhibits a combination of favorable cutting-edge strength, and unique cutting-edge geometry, thus, allowing milling operations at relatively high feed rates. The cutting insert includes at least four convex cutting edges. Certain embodiments of square cutting inserts will have four convex cutting edges which may be connected by nose corner regions. The convex cutting edge may comprise at least one of a circular arc, a portion of an ellipse, a portion of a parabola, a multi-segment spline curve, a straight line, or combinations of these. In one aspect, the convex cutting edge comprises a first curved cutting-edge region formed by a circular arc having a radius greater than or equal to two times a radius of the largest circle that may be inscribed on the top surface. The convex cutting edge further comprises a second, smaller curved cutting-edge region formed by a circular arc having a radius less than or equal to the diameter of the largest circle that may be inscribed on the top surface.

Certain embodiments of the disclosure are directed to cutting inserts providing a combination of advantages exhibited by round-shaped cutting inserts having a very large radius, and square-shaped inserts of conventional size adapted for conventional use in a variety of machining applications. Certain other embodiments of the disclosure are directed to a milling cutting tool including embodiments of unique cutting inserts of the disclosure.

These features are provided by an embodiment of a cutting insert having a relatively large cutting edge defined by a curvature radius arc. The cutting insert maintains the overall size of the insert as measured by the diameter of an inscribed circle. Additionally, embodiments of the present invention may comprise cutting inserts with the general shape of any standard cutting insert having four or more sides, such as a square, rhombus, or other cutting insert shapes. In the simplest form the convex cutting edge is in the form of an arc of a circle having a relatively large radius when compared to the radius of a circle inscribed in the top face of the insert. The arc of a circle is considered to be relatively large if the radius of the arc is greater than or equal to two times the radius of the largest circle that may be inscribed in the top surface of the cutting insert. In certain embodiments, the radius of the arc may be greater than or equal to 5 times the radius of the largest circle that may be inscribed in the top surface of the cutting insert, for certain other applications, results may be improved if radius of the arc is greater than or equal to 10 times the radius of the largest circle that may be inscribed in the top surface of the cuffing insert. The convex cutting edge has been described initially as comprising a circular arc, however, the convex cutting edge may also comprise portions of an ellipse, portions of a parabola, multi-segment line curves, straight lines, and combinations of these.

Additionally, these features are provided by an embodiment of a cutting insert having a relatively small cutting edge defined by a curvature radius arc.

As a result, embodiments of the cutting insert of the disclosure may have a convex cutting edge, such as a first curved cutting-edge portion with a relatively large curvature radius and a second curved cutting-edge portion with a relatively small curvature radius for generating a relatively smooth cut and relatively thin chips. A cutting insert having a convex cutting edge with first and second curved cutting-edge portions allows a greater length of engagement for the convex cutting edge than a similar conventional cutting insert with a linear cutting edge for the same depth of cut. This reduces the stress per unit length of the cutting edge and may, in turn, enable the use of relatively high feed rates or longer insert life in comparison with conventional cutting inserts employed in face milling operations. The convex cutting edge may be formed on one or more cuffing edges of the cutting insert. Preferably, all the cutting surfaces have convex edges so that the tool is fully indexable.

Another advantage provided by certain embodiments of the cutting insert of the disclosure draws on features of a square-shaped insert, which typically are relatively robustly designed such that the same cutting insert can be used for plunge, slot, and ramping milling applications, in addition to high feed face milling applications. Also, a cutter body according to certain embodiments of the disclosure may be designed such that the same insert pocket can receive cutting inserts of different convex cutting edges. Accordingly, embodiments of the cutting insert of the present disclosure perform in a fashion similar to round-shaped cutting insert having a relatively large radius but are much more versatile.

Embodiments of the disclosure include a generally square-shaped cutting insert with four convex cutting edges. The four cutting edges may or may not be identical. In addition, each of the convex major cutting edges may include several regions. For example, a first region may include a first curved cutting-edge portion having a relatively large curvature radius, and a second region may include a second curved cutting-edge portion having a relatively smaller curvature radius. One or more other regions of each convex cutting edge include a substantially straight or linear cutting edge, as viewed from a top portion of the cutting insert. The first curved cutting-edge portion may form a generally conical clearance (or relief) surface on a side surface of the cutting insert. Similarly, the second curved cutting-edge portion may form a generally conical clearance (or relief) surface on a side surface of the cutting insert. Based on combining features of a relatively large round-shaped insert and a square-shaped insert of conventional size, a method has been developed, discussed below, that may be used to guide the design of the cutting edges of certain embodiments of the cutting insert of the present invention.

Certain machining applications require a relatively positive cutting action. Therefore, a chip breaker feature may also optionally be included in embodiments of the cutting inserts of the present disclosure. A chip breaker is typically a built-in feature at the top portion of a milling cutting insert. A chip breaker often is characterized by certain basic parameters, such as groove depth, rake angle, backwall land and groove width, to provide positive cutting actions with lower cutting power in face milling operations.

Embodiments of the cutting insert according to the disclosure may be produced in the form of, for example, face milling inserts. Relative to conventional cutting inserts having linear cutting edges, embodiments of the cutting inserts according to the present invention may allow significantly increased feed rates, reduced radial cutting forces, increase rates of material removal and increased cutting insert life. Embodiments of the cutting insert may be robustly designed for use in other milling operations, such as ramping, plunging, and slotting. In addition, certain embodiments of a cutter body, disclosed herein, are designed to include insert pockets that will accept various cutting inserts with convex cutting edges.

In one aspect, a cutting insert comprises a top surface, a bottom surface with a perimeter that is less than a perimeter of the top surface, a plurality of side surfaces connecting the top surface and the bottom surface, a convex cutting edge formed at an intersection between each side surface and the top surface, and a nose corner region connecting adjacent convex cutting edges. Each convex cutting edge comprises a first curved cutting-edge region formed with a radius greater than or equal to a radius of the largest circle that may be inscribed on the top surface. Each convex cutting edge also comprises a second curved cutting-edge region disposed between the first curved cutting-edge region and the nose corner region. The second curved cutting-edge region is formed with a radius less than or equal to the diameter of the largest circle that may be inscribed on the top surface.

In another aspect, a cutting insert comprises a top surface, a bottom surface with a perimeter that is less than a perimeter of the top surface, a plurality of side surfaces connecting the top surface and the bottom surface, a convex cutting edge formed at an intersection between each side surface and the top surface, and a nose corner region connecting adjacent convex cutting edges. Each convex cutting edge comprises a first curved cutting-edge region formed with a radius greater than or equal to a radius of the largest circle that may be inscribed on the top surface. Each convex cutting edge comprises a second curved cutting-edge region disposed between the first curved cutting-edge region and the nose corner region, the second curved cutting-edge region formed with a radius less than or equal to the diameter of the largest circle that may be inscribed on the top surface. Each convex cutting edge comprises a first straight cutting-edge region disposed between the second curved cutting-edge region and the nose corner region. Each convex cutting edge comprises a second straight cutting-edge region disposed between the first straight cutting-edge region and the nose corner region.

These and other advantages will be apparent upon consideration of the following description of certain embodiments.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIGS. 1(A), 1(B), and 1(C) illustrate variations in the average chip thickness for lead angles of 45°, 75°, and 90° of a substantially square-shaped cutting insert with a linear cutting edge in a typical milling operation, wherein the lead angle is measured from the direction of travel of the insert to the cutting edge of the insert;

FIG. 2 illustrates variation in average lead angle for different depths of cut for application of a substantially round-shaped cutting insert in a typical milling operation;

FIG. 3 illustrates the difference in the extent of engaged cutting edge between a substantially round-shaped cutting insert with an 80 mm diameter and a substantially round-shaped cutting insert with a 20 mm diameter for a milling operation with a 5 mm depth of cut;

FIGS. 4(A)-(D) illustrate different views of an embodiment of a cutting insert with convex cutting edges according to the present disclosure;

FIGS. 5(A)-(E) illustrate several configurations for a convex cutting edge of a cutting insert according to the present disclosure;

FIGS. 6(A)-(E) depict steps in the method to prepare an embodiment of the cutting insert of the disclosure with at least four convex cutting edges;

FIG. 7 is a perspective view of a milling cutter tool comprising a cutting tool with a cutter body holding a plurality of cutting inserts;

FIG. 8 includes an enlargement of one pocket of a cutter body comprising a cutting insert and depicts the relationship between the cutting edge of an embodiment of the cutting insert of the disclosure and the axis of the cutter body and also depicts the linear movement of the cutting insert relative to the workpiece for face milling, plunge milling, slot milling, and ramping;

FIGS. 9(A)-(B) is a top plan views and side views of an embodiment of the cutting insert of the present invention comprising a convex cutting edge partially defined by a circular arc with a radius of 22.5 mm and 55 mm, respectively; and

FIG. 10 is a top and cross-sectional view taken along line A-A of another embodiment of the cutting insert of the disclosure comprising a chip breaking geometry on the top surface.

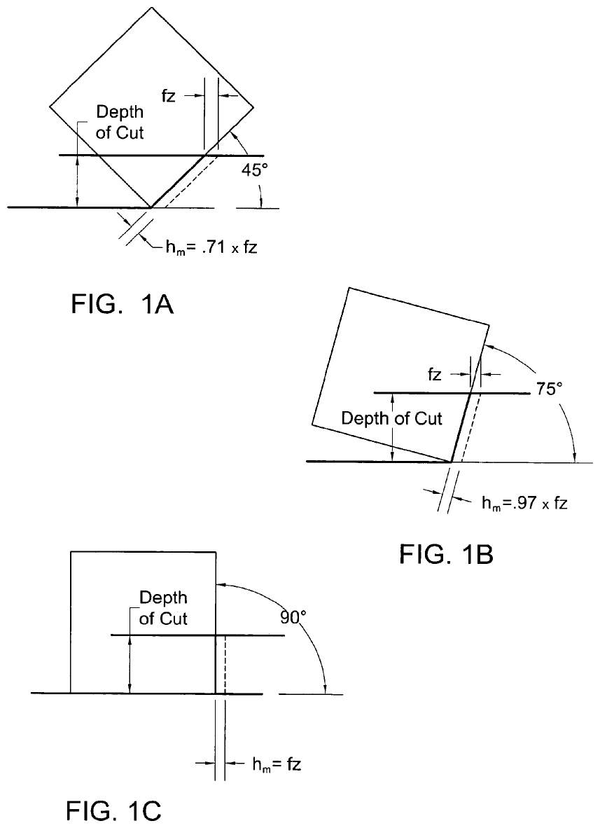

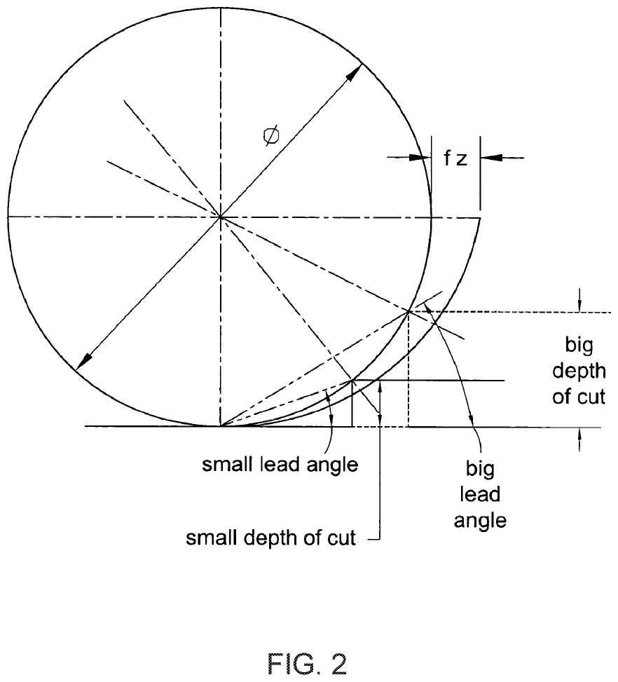

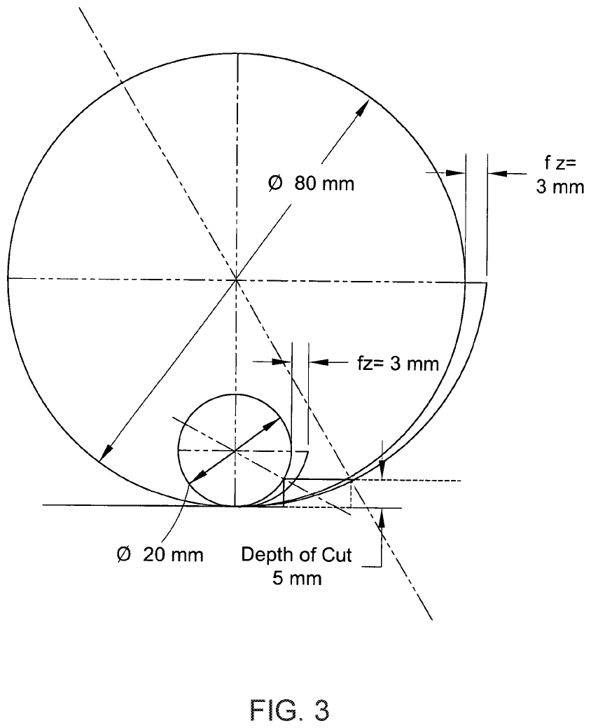

### DETAILED DESCRIPTION

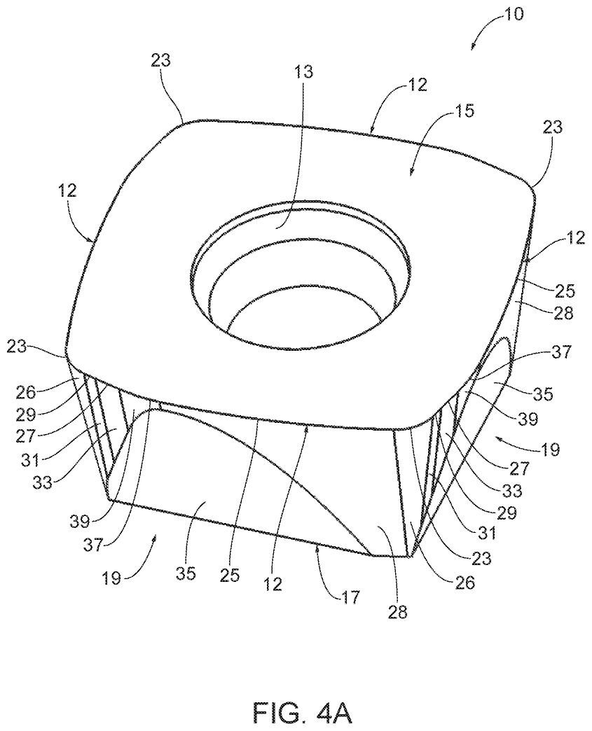

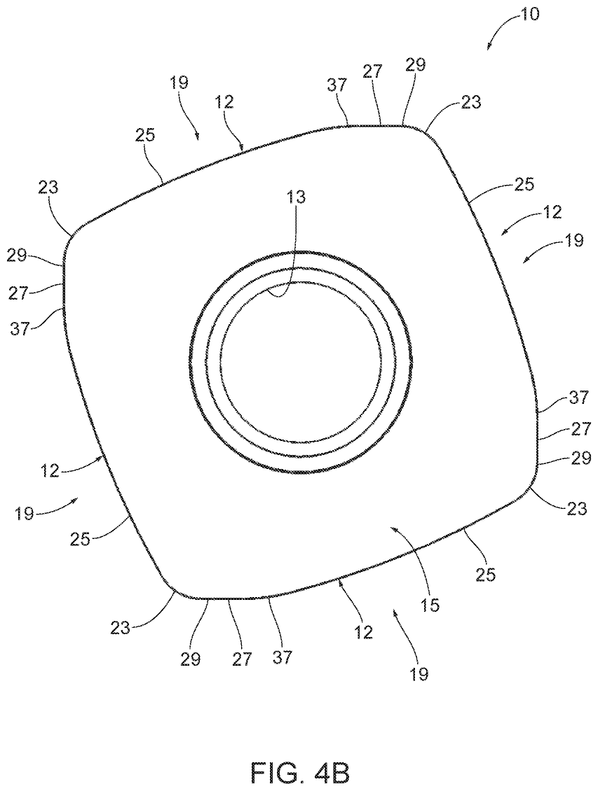

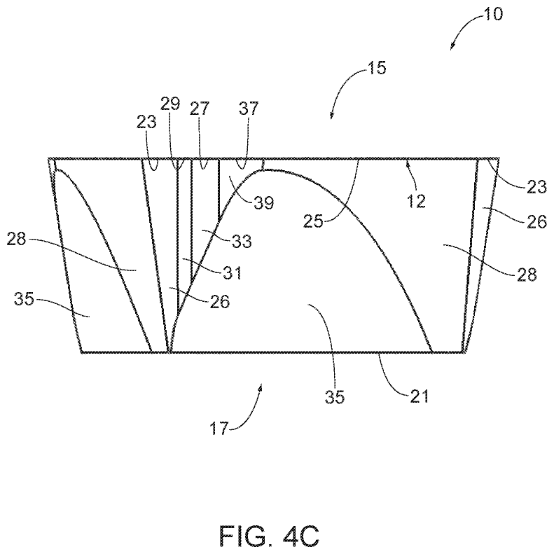

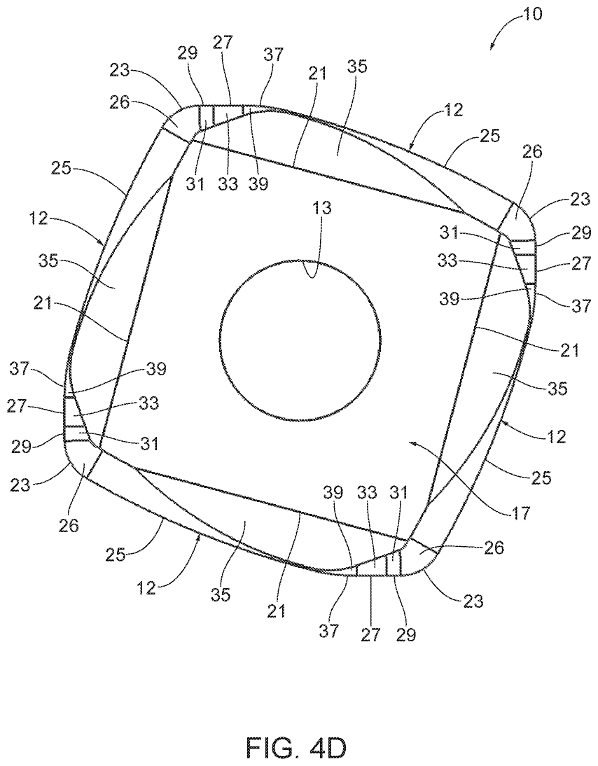

Referring now to FIG. 4, a cutting insert 10 is shown according to an aspect of the disclosure. The cutting insert 10 may be made of any of the various materials adapted for cutting applications. Such materials include wear resistant materials, such as steel, metal carbides, composites, such as aluminum oxide and metal carbides, tungsten carbides, ceramics, cermets as well as other materials known in the art. The material may additionally be coated to improve the properties of the cutting insert in certain applications.

As shown in FIG. 4(A), the cutting insert 10 includes a central bore 13, a top face 15, a bottom face 17, and four identical convex cutting edges 12 formed around the periphery of the top face 15. FIG. 4(B) is a top view of the cutting insert 10, looking down at the top surface 15. FIG. 4(C) is a side elevational view of the cutting insert 10. FIG. 4(D) is a bottom view of the cutting insert 10, looking down at the bottom surface 17.

Directional phrases used herein, such as, for example, left, right, front, back, top, bottom and derivatives thereof, relate to the orientation of the elements shown in the drawings and are not limiting upon the claims unless expressly recited therein. Identical parts are provided with the same reference number in all drawings.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Throughout the text and the claims, use of the word “about” in relation to a range of values (e.g., “about 22 to 35 wt %”) is intended to modify both the high and low values recited, and reflects the penumbra of variation associated with measurement, significant figures, and interchangeability, all as understood by a person having ordinary skill in the art to which this disclosure pertains.

For purposes of this specification (other than in the operating examples), unless otherwise indicated, all numbers expressing quantities and ranges of ingredients, process conditions, etc., are to be understood as modified in all instances by the term “about”. Accordingly, unless indicated to the contrary, the numerical parameters set forth in this specification and attached claims are approximations that can vary depending upon the desired results sought to be obtained by embodiments. At the very least, and not as an attempt to limit the application of the doctrine of equivalents to the scope of the claims, each numerical parameter should at least be construed in light of the number of reported significant digits and by applying ordinary rounding techniques. Further, as used in this specification and the appended claims, the singular forms “a”, “an” and “the” are intended to include plural referents, unless expressly and unequivocally limited to one referent.

Notwithstanding that the numerical ranges and parameters setting forth the broad scope are approximations, the numerical values set forth in the specific examples are reported as precisely as possible. Any numerical value, however, inherently contains certain errors necessarily resulting from the standard deviation found in their respective testing measurements including that found in the measuring instrument. Also, it should be understood that any numerical range recited herein is intended to include all sub-ranges subsumed therein. For example, a range of “1 to 10” is intended to include all sub-ranges between and including the recited minimum value of 1 and the recited maximum value of 10, i.e., a range having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

In the following specification and the claims, a number of terms are referenced that have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

It is to be understood that certain descriptions of the disclosure have been simplified to illustrate only those elements and limitations that are relevant to a clear understanding of the present invention, while eliminating, for purposes of clarity, other elements. Those of ordinary skill in the art, upon considering the present description of the invention, will recognize that other elements and/or limitations may be desirable in order to implement the present invention. However, because such other elements and/or limitations may be readily ascertained by one of ordinary skill upon considering the disclosure and are not necessary for a complete understanding of the disclosure, a discussion of such elements and limitations is not provided herein. For example, as discussed herein, cutting inserts of the disclosure may be produced in the form of face milling inserts and other inserts for materials cutting. The manners in which cutting inserts are manufactured is generally understood by those of ordinary skill in the art and, accordingly, are not described in detail herein. In addition, all the geometric shapes should be considered to be modified by the term “substantially” wherein the term “substantially” means that the shape is formed within typical design and manufacturing tolerances for cutting inserts.

Furthermore, certain embodiments of the disclosure are in the form of face milling cutting inserts. It will be understood, however, that the present invention may be embodied in forms and applied to end uses that are not specifically and expressly described herein. For example, one skilled in the art will appreciate that embodiments of the present invention may be manufactured as cutting inserts for other methods of removing metal from work pieces.

As shown in FIGS. 4(A), 4(C) and 4(D), each side surface 19 of the cutting insert 10 includes several clearance surfaces formed between the convex cutting edge 12 and the bottom edge 21 formed around the periphery of the bottom face 17. In the illustrated embodiment, each of the four convex cutting edges 12 consists of several regions, including a first curved cutting-edge region 25 with a large curvature radius, a second curved cutting-edge region 37 with a relatively smaller curvature radius, and two substantially straight (i.e., linear or planar) cutting-edge regions 27, 29. The four convex cutting edges 12 of cutting insert 10 are connected by nose corner regions 23 with a curvature radius.

Although the convex cutting edges 12 of cutting insert 10 include these several regions, alternate embodiments of the cutting insert 10 of the present disclosure may include four identical convex cutting edges 12 including only a nose corner region 23, a first curved cutting edge region 25 with a large curvature radius and a second curved cutting edge region 37 with a relatively smaller curvature radius. In this embodiment, the second curved cutting-edge region 37 extends from the nose corner region 23 to the first curved cutting-edge region 23, and the first curved cutting-edge region 23 extends from the second curved cutting-edge region 37 to an adjacent nose corner region 23. Accordingly, such embodiments do not include the one or more substantially straight (i.e., linear) cutting-edge regions 27, 29.

Returning again to cutting insert 10 of FIG. 4, each region of the cutting edge 12 of cutting insert 10 forms a distinct clearance surface on the side surface 19 of the insert 10. Each such clearance surface extends downward from the cutting edge 12 of the insert 10 to the bottom edge 21. For example, as best shown in FIGS. 4(A), 4(C) and 4(D), a conical clearance surface 26 extends downward from the nose corner region 23, a conical clearance surface 28 extends downward from the curved cutting edge region 25, a planar clearance surface 31 extends downward from the straight cutting edge region 27, a planar clearance surface 33 extends downward from the straight cutting edge 29 region, and a conical clearance surface 39 extends downward from the curved cutting edge region 37. The cutting insert 10 also includes secondary planar clearance surface 35, which extends from the clearance surfaces 28, 31, 33 and 39 to the bottom edge 21 of the insert 10.

According to the embodiment of FIG. 4, a substantially square-shaped cutting insert 10 includes four convex cutting edges 12, each convex cutting edge 12 having the curved cutting-edge region 25 with a relatively large curvature radius, and the curved cutting-edge region 37 with a relatively smaller curvature radius as viewed from the top surface 15 of the cutting insert 10. The large curvature radius of the curved cutting-edge region 25 is preferably significantly larger than the nominal radius of the insert's inscribed circle. The curved cutting-edge region 25 then forms the conical clearance surface 28 on the side surface 19 of the cutting insert 10. Additionally, the small curvature radius of the curved cutting-edge region 37 is preferably smaller than the radius of curvature of the curved cutting-edge region 25. The curved cutting-edge region 37 then forms the conical clearance surface 39 on the side surface 19 of the cutting insert 10.

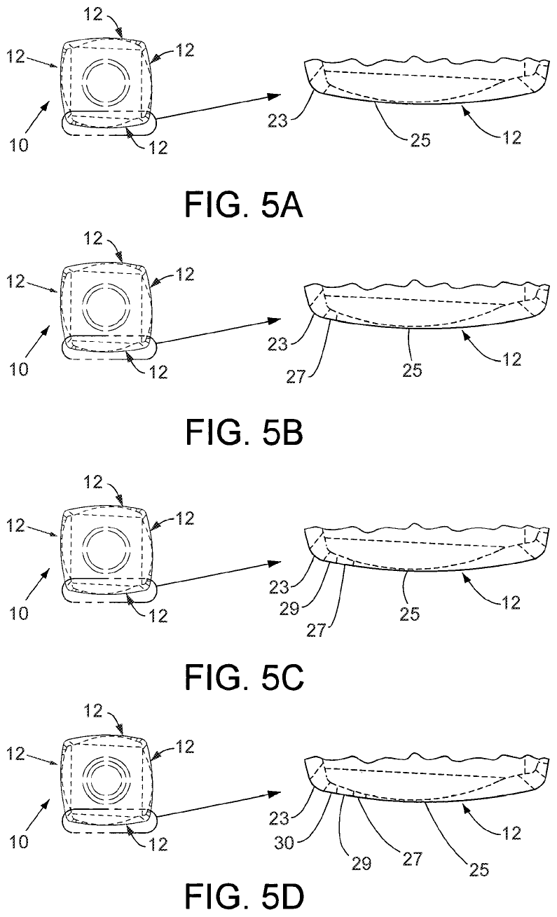

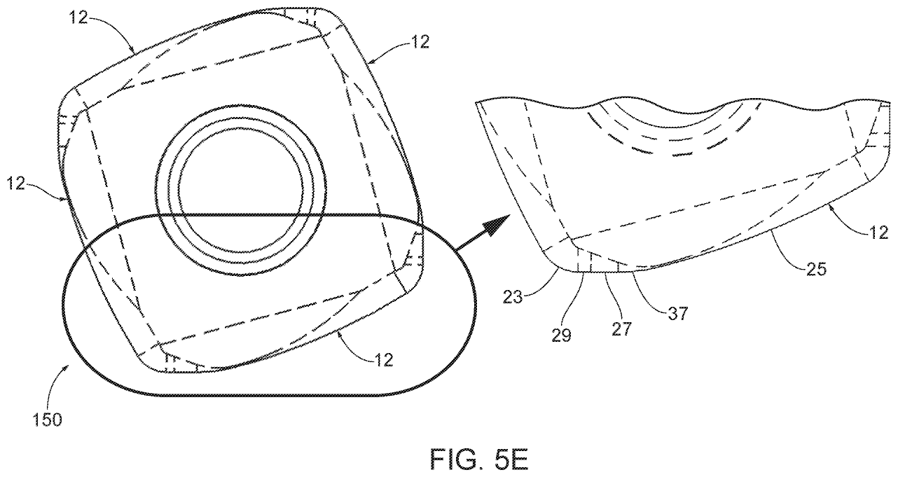

Accordingly, it will be understood that different embodiments of the cutting insert of the disclosure may include different combinations of distinct cutting-edge regions. For example, FIG. 5 illustrates various designs of the cutting edges of inserts of the disclosure.

FIGS. 5(A)-(E) depict various configurations for the substantially square-shaped cutting insert 10 including four identical convex cutting edges 12 of the disclosure. In the variation shown in FIG. 5(A), the cutting insert 10 includes only a nose corner region 23 and one curved cutting-edge region 25. The cutting edges 12 of the cutting insert 10 lacks the second curved cutting-edge region 37 and the straight cutting-edge regions 27, 29.

FIG. 5(B) depicts the substantially square-shaped cutting insert 10 including four identical convex cutting edges 12. The cutting insert 10 includes the nose corner region 23, one substantially straight cutting-edge region 27, and the curved cutting-edge region 25 having a relatively large curvature radius.

FIG. 5(C) depicts the substantially square-shaped cutting insert 10 including four identical cutting edges 12. The cutting insert 10 includes the nose corner region 23, two adjacent substantially straight cutting-edge regions 27, 29, and the curved cutting-edge region 25 having a relatively large curvature radius.

FIG. 5(D) depicts the substantially square-shaped cutting insert 10 including four identical convex cutting edges 12. The cutting insert 10 includes the nose corner region 23, three adjacent substantially straight cutting-edge regions 27, 29, and 30, and the curved cutting-edge region 25 having a relatively large curvature radius.

FIG. 5(E) depicts the substantially square-shaped cutting insert 10 including four identical convex cutting edges 12. The cutting insert 10 includes a nose corner region 23, two adjacent substantially linear cutting-edge regions 27 and 29, the curved cutting-edge region 25 having a relatively small curvature radius, and a curved cutting-edge region 37 having a relatively smaller curvature radius. It will be appreciated that the cutting insert 10 may only include the nose corner region 23, and the curved cutting-edge regions 25 and 37 and omit any or all of the straight cutting-edge regions 27, 29 and 30. It should be appreciated that the invention is not limited by the number of straight cutting-edge regions, and that the cutting insert 10 of the disclosure can include any number of straight cutting-edge regions.

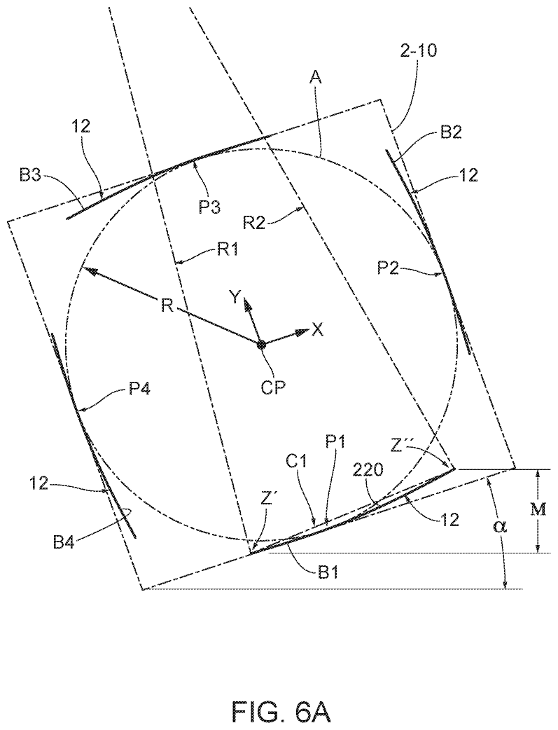

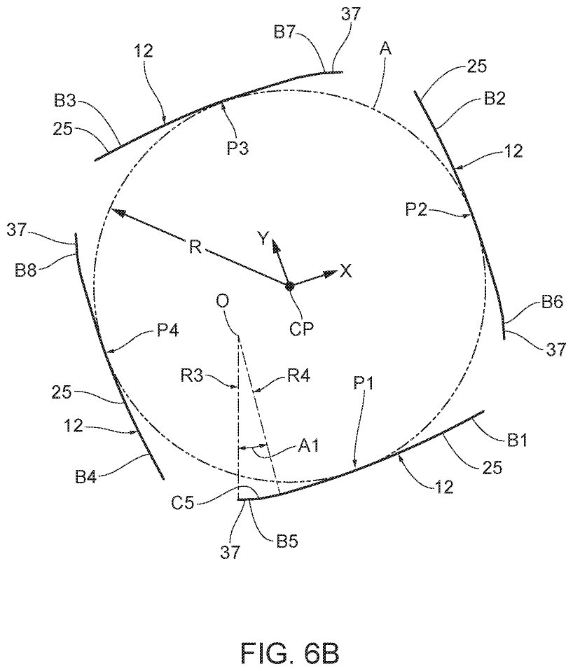

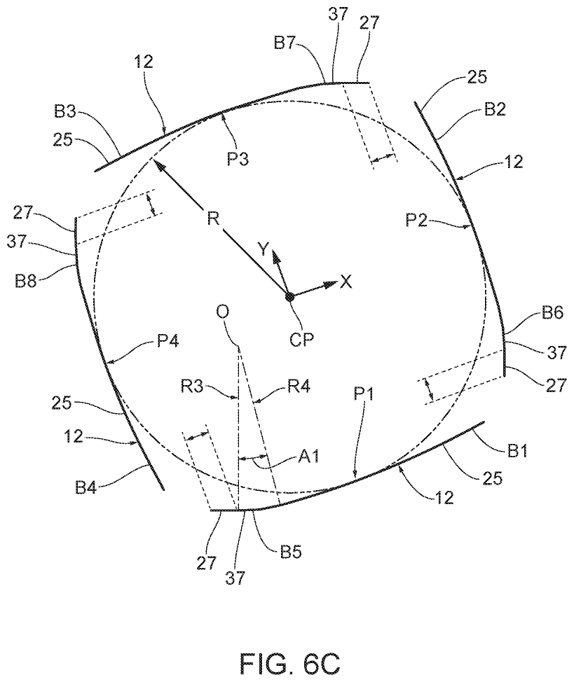

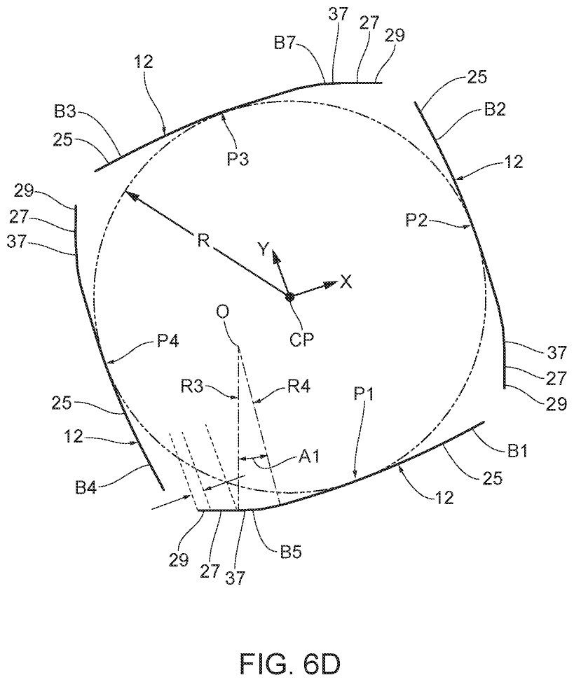

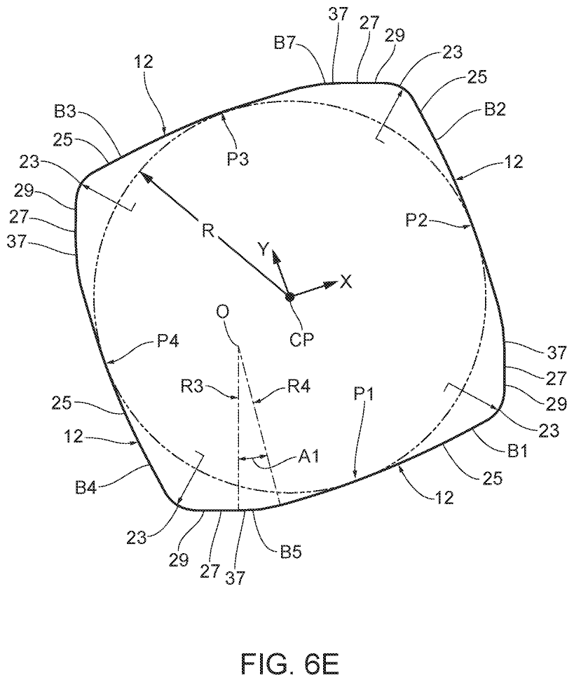

Certain embodiments of cutting inserts according to the present disclosure may be generally mathematically described. As an example, reference is made to FIG. 6. As known in the art, the diameter of the inscribed circle, A, (i.e., the circle of largest radius fitting within the perimeter of the insert surface) generally represents the size of a cutting insert. With reference to FIG. 6(A), assume that the origin (i.e., point (0,0)) of Cartesian coordinate system X-Y is at the center, CP, of the inscribed circle, A, within the cutting insert represented by the square 210. The equation of the inscribed circle, A, can be described be the following equation (II):

x²+y²=R² (II)

where, R, is the radius of inscribed circle, A, as shown in FIGS. 6B-6E. A unique feature of certain embodiments of cutting inserts according to the present disclosure is the combination of certain advantages of a relatively large round-shaped insert and certain advantages of a square-shaped insert of conventional size. Each of the four convex cutting edges 12 of the substantially square-shaped insert will be tangent to the inscribed circle, A, at their points of contact, P₁, P₂, P₃, and P₄, which can be determined by the above equation, and can be represented by a group of tangential equations of the inscribed circle as follows:

Pᵢₓx+P_{iy}y=R² (III)

where Pᵢₓ and P_{iy} are X and Y coordinates of the tangent points and i=1, . . . , 4. The square insert is set by a lead angle, α, which is directly related to the maximum depth of cut, M, to be used when cutting with a round-shaped insert. Assume the bottom side of the square 210 in FIG. 6(A) is tangent to the inscribed circle, A, at the point P₁(P₁ₓ, P_{1y}). In that case, P₁ₓ=R*(sin α) and P_{1y}=−R*(cos α). By substituting the point (P₁ₓ, P_{1y}) into the above equation, we obtain the following equation (IV) for the lower side of the square 210 in FIG. 6:

(sin α)x−(cos α)y=R² (IV)

where α is the lead angle.

Equations defining the remaining three sides of the square 210 in FIG. 6 may be derived in a similar fashion, resulting in the following set of equations (V) (VIII), one representing each side of the square:

(sin α)x−(cos α)y=R² (V)

(cos α)x+(sin α)y=R² (VI)

−(sin α)x+(cos α)y=R² (VII)

−(cos α)x−(sin α)y=R² (VIII)

The above group of equations is based on the lead angle that corresponds to the maximal depth of cut. Each of the four cutting edges of the insert, including the curved cutting-edge region having a relatively large curvature radius, will be confined by square 210 formed by equations (V)-(VIII).

Once the above equations (V)-(VIII) have been generated, a first step within the design procedure of certain embodiments of cutting inserts according to the disclosure may be to add a first region to the convex cutting edge 12, such as in this example, the curved cutting-edge region 25 of the cutting insert 10. An arc of an identical length with a radius greater than inscribed circle, A, is provided on each side of square 210, tangent to square 210 at each of points P₁-P₄. The four identically positioned arcs are shown in FIG. 6(A) as arcs B₁-B₄. In certain embodiments of the cutting insert, a chord of each of the four arcs B₁-B₄ that is parallel to the particular adjacent side of square 210 defines the curved cutting-edge region 25. Thus, with reference to FIG. 6(A), the arc, B₁, has radius of curvature greater than the radius of inscribed circle, A. Dotted line, Z, is parallel to the side of square 210 tangent to arc B₁ and intersects arc B₁ at points z′ and z″. The intermediate points z′ and z″ of chord, C₁, of arc, B₁, defines the curved cutting-edge region 25 of the cutting insert 10. The relatively large radius of curvature of the curved cutting-edge region 25 is indicated by dotted line segments R₁ and R₂, which extend from curved cutting-edge region 25 toward the center point of the radius of curvature defining arc, B₁. If extended the distance of the radius of curvature of arc, B₁, line segments R₁ and R₂ will meet at a point well beyond center point, CP, of the circle A.

Because the chord, C₁, of the arc, B₁, is parallel to the adjacent side of square 210, the defined curved cutting-edge region 25 with large curvature radius, has the same lead angle, as seen in the above group of equations. In situations where the cutting insert provided in the disclosure is to be used primarily for face milling, the tangential line at lower left end point, Z₁, of the arc, B₁, to be perpendicular to the cutter body axis, such that good surface finish can be insured on the machined surface that is perpendicular to the cutter body axis. Then, according to the geometric relationship shown in FIG. 6, the length of the chord, C₁, can be represented as a function of the maximal depth of cut, M, and the lead angle, α, as shown in the following equation (IX):

L_{b}=Mₘₐₓ/sin α (IX)

In such case, the curvature radius, R_{b}, of the curved cutting-edge region is determined by the following formula:

$${R}_{b} = \frac{{L}_{b}}{2 - sin ( θ / 2 )} = \frac{{L}_{b}}{2 ( sin ∝ )} \qquad ( X )$$

where θ is the arc center angle.

A second step within the design procedure of certain embodiments of cutting inserts according to the disclosure may be to add a second region to the convex cutting edge 12, such as in this example, the curved cutting-edge region 37 that is tangent to the lower left end point and/or lower right end point of the arc forming the curved cutting-edge region 25 of the cutting insert 10. Thus, an arc of an identical length with a radius less than inscribed circle, A, is provided adjacent to the curved cutting-edge region 25. The four identically positioned arcs are shown in FIG. 6(B) as arcs B₅-B₈. In certain embodiments of the cutting insert, a chord C₅-C₈ of each of the four arcs B₅-B₈ defines the curved cutting-edge region 37. Thus, with reference to FIG. 6(B), the arc, B₅, has radius of curvature equal to or less than the diameter (i.e., 2×R) of the inscribed circle, A. The chord, C₅, of arc, B₅, defines the curved cutting-edge region 37 of the cutting insert 10. The relatively smaller radius of curvature of the curved cutting-edge region 37, as compared to the curved cutting-edge region 25, is indicated by dotted line segments R₃ and R₄, which extend from curved cutting-edge region 37 toward the center point, O, of the radius of curvature defining arc, B₅, which meet at a point at or before center point, CP, of the inscribed circle, A.

The curved cutting-edge region 37 disposed between the nose corner region 23 and the curved cutting-edge region 25 of the convex cutting edge 12 allows to significantly increase or decrease the Depth of Cut (DOC). A small increase of the DOC, for example, about 0.5 mm, will allow to reduce the machining time around about 20% with respect to high feed facing milling cutting operations. A brief calculation shows an increase of about 25% of the Metal Removal Rate (MRR) with only an increase in the DOC of about 0.5 mm.

In some applications, for example, general engineering, mold, dies, and the like, this increase of the DOC also generates an excessive increase in power consumption. In this case, more powerful milling machines may be required.

In some other applications in which High Temperature Alloy (HTA) material is to be machined, a higher DOC of about 0.5 mm will generate an increase of about 25% of the Metal Removal Rate (MRR) with a about 20% increase in power consumption. It is more than acceptable for users because they do not need a powerful milling machine for machining this kind of material, but rather stability and rigidity.

As shown in FIGS. 6B-E, the radii, R3 and R4, is shown to be less than the radius, R, of the inscribed circle, A. However, the radii, R3 and R4, can be larger than the radius, R, but less than or equal to the diameter (i.e., 2×R) of the inscribed circle, A. In addition, an angle, A1, formed between the radii, R3 and R4, can be in range between about 0 degrees and about 30 degrees. It should be noted that the curved cutting-edge region 37 can be also be replaced with one line or some multitude lines, one spline or some multitude of splines, and the like.

An optional third step within the design procedure of certain embodiments of cutting inserts according to the disclosure may be to add a third region to the convex cutting edge 12, such as in this example, the straight cutting-edge region 27 that is perpendicular to the cutting insert axis and tangent to the lower left end point of the arc forming the curved cutting-edge region 37 of the cutting insert. This third step is illustrated by FIG. 6(C), in which the linear cutting-edge region 27 of similar length is added to the end of each curved cutting-edge region 37.

An optional fourth step within the design procedure of certain embodiments according to the disclosure may be to add the second straight cutting-edge region 29 to the end of the second straight cutting edge-region 27 on each convex cutting edge 12. The second straight cutting-edge region 29 may be set at a relatively small angle relative to the first straight cutting-edge region 27. This step is illustrated in FIG. 6(D), in which the second linear cutting-edge region 29 of similar length is added to the end of first linear cutting-edge region 27.

A further additional step may be to add the nose corner regions 23 to the cutting insert 10. In this embodiment, the nose corner regions 23 each have an identical radius that smoothly connects and is tangent to the second linear cutting-edge region 27 and the curved cutting-edge region 25 that each nose corner region 23 connects. This step is illustrated in FIG. 6(E), in which the four identical nose corner regions 23 complete the profile of the cutting insert 10.

Once the complete convex cutting edge 12 shown in FIG. 6(E) is defined, all the clearance surfaces (i.e., facets) on the side surfaces 19 of the cutting insert 10 may be formed. In the embodiment shown in FIG. 4, the conical clearance (or relief) surface 28 may be formed below the curved cutting-edge region 25 having a large curvature radius, then connected by the planar clearance face 35, which is extended to the bottom edge 21 of the cutting insert 10. The large curvature radius on each curved cutting-edge region 25 of the cutting insert 10 is much larger than the nose radius 23 on each corner of the cutting insert 10, for example, a curvature radius of 55 mm on the curved cutting-edge region 25 of the convex cutting edge 12 is compared to the nose radius of 0.8 mm on the insert corner. The conical clearance (or relief) surface 39 may be formed below the curved cutting-edge region 37 having a relatively smaller curvature radius as compared to the curved cutting-edge region 25.

Additionally, the planar clearance surface 33 is formed below the straight cutting-edge region 29 (if included) and the planar clearance surface 31 is formed as a facet below the straight cutting-edge region 27 (if included), both on each of four side surfaces 19 of the cutting insert 10. The planar clearance surface 33 functions as a cutting facet to produce machined surface perpendicular to the cutting axis while the planar clearance surface 31 as an approach angle for plunge milling along the direction of cutting. Finally, the conical clearance surface 26 is formed below the nose corner region 23.

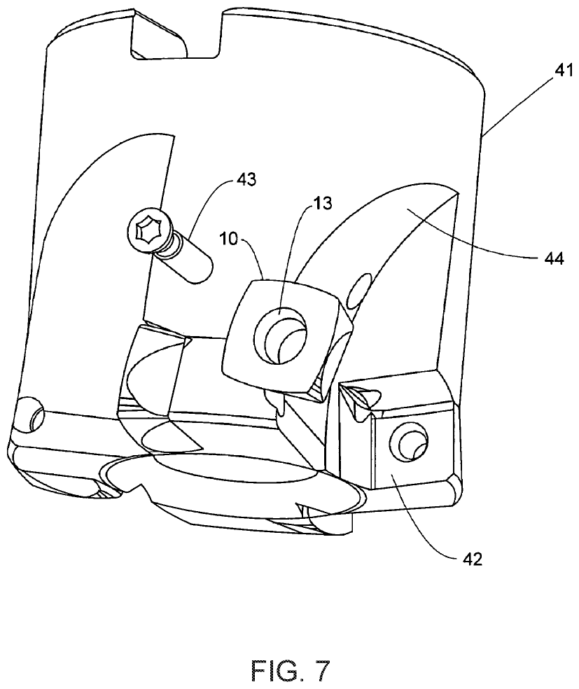

As shown in FIG. 7, a plurality of the cutting inserts, such as the embodiment of cutting insert 10, may be assembled into a cutting body 41 of a cutting tool 40 and securely positioned into a pocket 42 by a screw 43 through the center bore 13 on the cutting insert 10. The cutter body 41 may also include a flute 44 that helps evacuate the chips produced during machining.

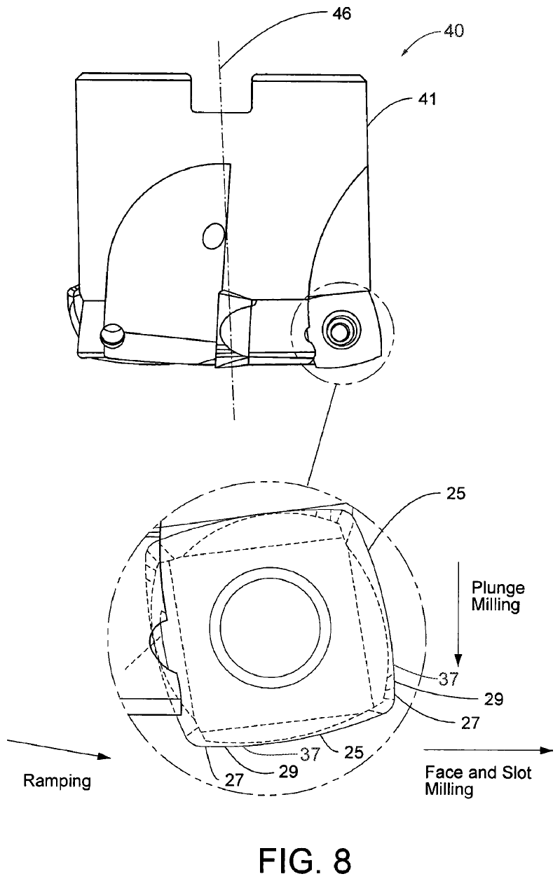

As shown in FIG. 8, the straight cutting-edge region 29 may be perpendicular to the cutting axis 46 to guarantee good surface finish on the machined surface in certain face milling applications. The cutter body 41 is designed in a way that the same pocket can receive the cutting insert having same size yet different convex cutting edge and maintain the perpendicular relationship between the straight cutting edge 29 of the insert 10 and the axis of the cutter 46.

The cutting tool 40 may also designed in a way that it allows using the same insert sitting in the same pocket to perform multiple milling functions (facing, slotting, ramping, and plunging) as already shown in FIG. 8. This means that if the cutting action follows a direction along the machined surface that is perpendicular to the cutter axis 46, the inserts are performing face or slot milling operations; and if the cutting action follows a direction that is parallel to the cutter axis 46, the cutting inserts perform a plunge milling operation; and further if the cutting action follows a small angle to the surface of the work piece to be machined as shown in FIG. 8, the cutting insert performs a ramping operation.

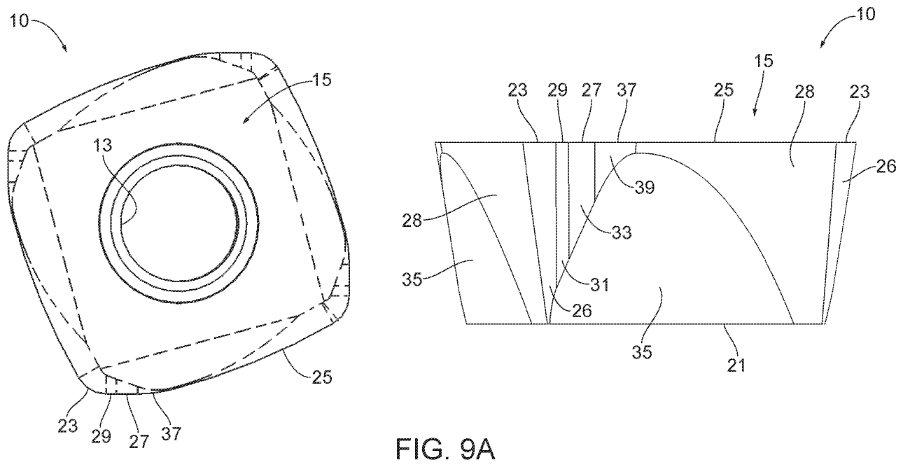

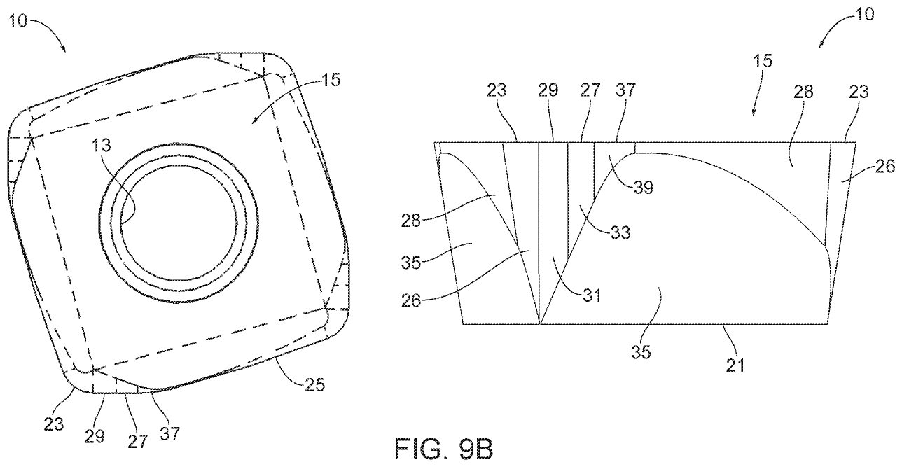

FIG. 9 shows an example of the cutting insert 10 of the disclosure having about 12.7 mm in diameter or about 6.35 mm in radius of the inscribed circle, IC, with two different large curvature radii on the convex cutting-edge region 25. In FIG. 9(A), the cutting insert 10 has a 22.5 mm radius curve as part of the convex cutting-edge region 25. In FIG. 9(B), the cutting insert 10 has 55 mm radius curve as part of the convex cutting-edge region 25.

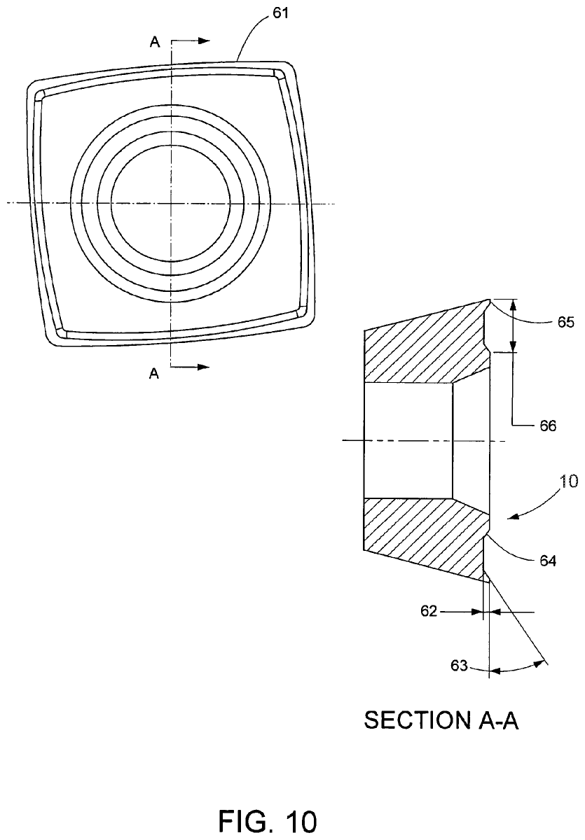

It should be appreciated that the cutting insert provided in this disclosure is not limited to a cutting insert with a top flat surface but also to the cutting inserts with a chip breaker on the top surface of the cutting insert. Referring now to FIG. 10, a design of the cutting insert 10 of the disclosure includes a chip breaker on the top surface 61. The chip breaker can be characterized by at least five basic parameters, for example, groove depth 62, rake angle 63, backwall 64, land 65 and groove width 66, as well as other chip breaking features known in the art. The function of the chip breaker which may be built into embodiments, the cutting inserts of the present invention allows the cutting insert and the associated cutter to be adapted to use in machining a variety of work materials.

It will be understood that the present description illustrates those aspects of the invention relevant to a clear understanding of the invention. Certain aspects of the invention that would be apparent to those of ordinary skill in the art and that, therefore, would not facilitate a better understanding of the invention have not been presented in order to simplify the present description. Although embodiments of the present invention have been described, one of ordinary skill in the art will, upon considering the foregoing description, recognize that many modifications and variations of the invention may be employed. All such variations and modifications of the invention are intended to be covered by the foregoing description and the following claims.

The patents and publications referred to herein are hereby incorporated by reference.

Having described presently preferred embodiments the invention may be otherwise embodied within the scope of the appended claims.

1. A cutting insert, comprising:
a top surface;
a bottom surface with a perimeter that is less than a perimeter of the top surface;
a plurality of side surfaces connecting the top surface and the bottom surface;
a convex cutting edge formed at an intersection between each side surface and the top surface; and
a nose corner region connecting adjacent convex cutting edges,
wherein each convex cutting edge comprises a first curved cutting-edge region formed with a radius greater than or equal to a radius of the largest circle that may be inscribed on the top surface, and
wherein each convex cutting edge comprises a second curved cutting-edge region disposed between the first curved cutting-edge region and the nose corner region, the second curved cutting-edge region formed with a radius less or equal to a diameter of the largest circle that may be inscribed on the top surface.

2. The cutting insert of claim 1, further comprising a first conical clearance surface extending between the first curved cutting-edge region and the perimeter of the bottom surface.

3. The cutting insert of claim 1, further comprising a second conical clearance surface extending between the second curved cutting-edge region and the perimeter of the bottom surface.

4. The cutting insert of claim 1, wherein each convex cutting edge comprises a first straight cutting-edge region disposed between the second curved cutting-edge region and the nose corner region.

5. The cutting insert of claim 4, further comprising a first planar clearance surface extending between the first straight cutting-edge region and the perimeter of the bottom surface.

6. The cutting insert of claim 4, wherein each convex cutting edge comprises a second straight cutting-edge region disposed between the first straight cutting-edge region and the nose corner region.

7. The cutting insert of claim 6, further comprising a second planar clearance surface extending between the second straight cutting-edge region and the perimeter of the bottom surface.

8. The cutting insert of claim 6, wherein each convex cutting edge comprises a third straight cutting-edge region disposed between the second straight cutting-edge region and the nose corner region.

9. The cutting insert of claim 8, further comprising a third planar clearance surface extending between the third straight cutting-edge region and the perimeter of the bottom surface.

10. The cutting insert of claim 1, wherein the first curved cutting-edge region comprises a circular arc having a radius greater than or equal to two times the radius of the largest circle that may be inscribed on the top surface.

11. The cutting insert of claim 1, wherein each convex cutting edge comprises at least one of a circular arc, a portion of an ellipse, a portion of a parabola, a multi-segment spline curve, a straight line.

12. The cutting insert of claim 1, wherein the nose corner region comprises at least one of a circular arc, a series of circular arcs, and a multi-segment spline curve.

13. The cutting insert of claim 1, further comprising chip breaking geometry on the top surface.

14. A cutting insert, comprising:
a top surface;
a bottom surface with a perimeter that is less than a perimeter of the top surface;
a plurality of side surfaces connecting the top surface and the bottom surface;
a convex cutting edge formed at an intersection between each side surface and the top surface; and
a nose corner region connecting adjacent convex cutting edges,
wherein each convex cutting edge comprises a first curved cutting-edge region formed with a radius greater than or equal to a radius of the largest circle that may be inscribed on the top surface,
wherein each convex cutting edge comprises a second curved cutting-edge region disposed between the first curved cutting-edge region and the nose corner region, the second curved cutting-edge region formed with a radius less than or equal to a diameter of the largest circle that may be inscribed on the top surface, and
wherein each convex cutting edge comprises one or more straight cutting-edge regions disposed between the second curved cutting-edge region and the nose corner region.

15. The cutting insert of claim 14, further comprising a first conical clearance surface extending between the first curved cutting-edge region and the perimeter of the bottom surface.

16. The cutting insert of claim 15, further comprising a second conical clearance surface extending between the second curved cutting-edge region and the perimeter of the bottom surface.

17. The cutting insert of claim 15, further comprising a first planar clearance surface extending between a first straight cutting-edge region and the perimeter of the bottom surface.

18. The cutting insert of claim 17, further comprising a second planar clearance surface extending between a second straight cutting-edge region and the perimeter of the bottom surface.

19. The cutting insert of claim 14, wherein each convex cutting edge comprises at least one of a circular arc, a portion of an ellipse, a portion of a parabola, a multi-segment spline curve, a straight line.

20. The cutting insert of claim 14, wherein the nose corner region comprises at least one of a circular arc, a series of circular arcs, and a multi-segment spline curve.

21. The cutting insert of claim 14, further comprising chip breaking geometry on the top surface.
